(19) United States
(12) Patent Application Publication
(10) Pub. No.: US 2003/0159537 A1
(43) Pub. Date: Aug. 28, 2003

(54) Eccentric crank rod

(76) Inventor: Sang Yeon Jo, Seoul (KR)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/009,238

(22) PCT Filed: Mar. 30, 2001
(86) PCT No.: PCT/KR01/00522

(30) Foreign Application Priority Data
Apr. 7, 2000 (KR) 2000-18351

(51) Int. Cl. G05G 1/00

(52) U.S. Cl. 74/579 R

(57) ABSTRACT

A crank rod used in converting reciprocal movement into rotation, more particularly to an eccentric crank rod for overcoming problems due to failure in conversion of a linearly applied force into a rotation output force at the highest position and the lowest position on a vertical line when the rod is used in converting reciprocal movement into rotation as in a connecting rod of an internal combustion engine or an external combustion engine, or as in a geared crank rod of a bicycle. The crank rod is formed by a biased ex tension (3), a main length portion (5) and an intermediate transition (4) unitarily connecting the biased extension (3) to the main length portion (5). A force-applying portion (6) is formed at an off-centered position nearby an end of the main length portion (5) Both the force-applying portion (6) and the end of the main length portion (5) usually stop at a position across a vertical line L through the center of a crank pin. Both a biased extension (3) and an intermediate transition (4) of the crank rod according to the present invention are formed to have an obtuse internal angle so that an end of the crank rod usually stops after passing over a vertical line regardless of either a weight or a force applied to the force-applying portion (6).

### TECHNICAL FIELD

This invention relates to a crank rod used in converting reciprocal movement into rotation, more particularly to an eccentric crank rod for overcoming problems due to failure in conversion of a linearly applied force into a rotation output force at the highest position and the lowest position on a vertical line when the rod is used in converting reciprocal movement into rotation as in a connecting rod of an internal combustion engine or an external combustion engine, or as in a geared crank rod of a bicycle.

### BACKGROUND OF THE INVENTION

A conventional crank rod for converting reciprocal movement into rotation cannot convert a linearly applied force into a rotation output force both at the highest position and at the lowest position on a vertical line. Thus, knocking is induced in a gasoline engine operated at a high compression ratio. This is also reason for lowered mechanical efficient and shortened lifetime of a diesel engine operated at a high compression ratio. Furthermore, this requires a heavier flywheel.

In a conventional bicycle, a geared crank rod with no flywheel is very difficult to pass the highest position when the bicycle runs up a hill. Another kind of bicycle, therefore, employs a change gear. A rider on a bicycle equipped with a change gear, however, feels oppressed since he cannot gain a high speed even though he rotates the crank rod quickly. Furthermore, a chain hung on the change gear easily escapes from a sprocket wheel. The inventor proposed a deformed crank rod used in a bicycle in a laid-open International Application having publication No. WO97/02174. The crank rod slightly generates a rotation force output at the highest position using a tension effect. The tension effect involves another problem of accumulated fatigue at an offset curving extension of the crank rod, which results in breaking within a shortened lifetime. Furthermore, the higher speed is, the poorer tension effect is.

Very important reason for the problems as aforementioned is the structure inhered in a conventional crank rod, which involves a stop attitude of the crank rod aligned with the vertical line when a weight hangs on a force-applying portion of the crank rod as shown in FIG. 1.

### SUMMARY OF THE INVENTION

According to this invention, an eccentric crank rod consists of a biased extension, an intermediate transition and a main length portion having a force-applying portion formed at an end. The biased extension starts from an end, at which a crank pin of the crank rod is inserted, and reaches the intermediate transition and then the main length portion. The main length portion has the force-applying portion formed at a position departed from the center of the crank rod so that an end of the main length portion and a force-applying portion always stop beyond the vertical line regardless of weight or force applied to the force-applying portion by the gravity acting on the biased extension and the intermediate transition.

The force-applying portion is formed at an off-centered position nearby an end of the main length portion. The force-applying portion has a proper length R and a proper angle X to maximize a trigonometric sine value by an angle between a force-applying direction P and the main length portion of the crank rod so that a force transmission loss is minimized.

Both the biased extension and the intermediate transition are directed to form an obtuse angle with adjacent portions. It is preferred that the maximum distance between the force-applying portion and the intermediate transition equals the sum of the length of a conventional crank rod and the diameter of a crank pin with a tolerance of ±5 mm allowed.

### BRIEF DESCRIPTION OF THE DRAWINGS

Several preferred embodiments of the present invention will be explained with reference to the accompanying drawings, in which:

FIG. 1 shows a front view of a conventional crank rod for explaining the fact that the crank rod stops when a force-applying portion of the crank rod reaches a vertical line through the center of a crank pin;

FIG. 2 shows a front view of an eccentric crank rod in an embodiment of the present invention, in which a force-applying portion further proceeds by a few distance in a rotating direction across a vertical line through the center of a crank pin; and

FIG. 3 shows an assembly in which two eccentric crank rods shown in FIG. 2 are assembled to explain force transmission using the same.

### DETAILED DESCRIPTION OF THE INVENTION

According to a preferred embodiment of the present invention, the crank is formed by a biased extension 3, a main length portion 5 and an intermediate transition 4 unitarily connecting the biased extension 3 to the main length portion 5. A force-applying portion 6 is formed at an off-centered position nearby an end of the main length portion 5. Both the force-applying portion 6 and the end of the main length portion 5 usually stop at a position across a vertical line L through the center of a crank pin. In other words, a force-applying portion of a conventional crank rod stops at the lowest position either when a mass is hung on the force-applying portion or when a force is applied to the force-applying portion. Thus, the other (not shown) of coupled crank rods is positioned at the highest position. At this time, a linear force applied to a force-applying portion of the other crank rod in a vertical downward direction is directed to the center of the crank pin, whereby no linear force is converted in a rotational force. In some cases, a flywheel is used to increase an inertia force to solve the problem. A crank rod disclosed in the aforementioned publication of WO97/02174 also stops on the vertical line when a mass is hung on the force-applying portion. Moreover, an end of the main length portion of the crank rod is not reached to the vertical line because of deformation of its tensioning portion.

In the eccentric crank rod according to the present invention, not only all end of the main portion but also the force-applying portion 6 passes over a vertical line L either when a mass is hung on the force-applying portion 6 or when a force is applied to the force applying portion 6, whereby the problem is solved. Furthermore, a trigonometric sine value between a force-applying direction P and tile crank rod is maximized at the position Inhere the transmitted force is maximized, the position is at 12° for a crank rod used in an engine and at 20° for a geared crank rod used in a bicycle.

The eccentric crank rod according to the present invention consists of a biased extension 3, an intermediate transition 4 and a main length portion 5. A force-applying portion 6 is formed at an eccentric portion of an end of the main length portion 5 so that the end of the main portion and the force-applying portion 6 usually passes over the vertical line L.

Operation of the eccentric crank rod according to the present invention will be explained in detail referring to the accompanied drawings

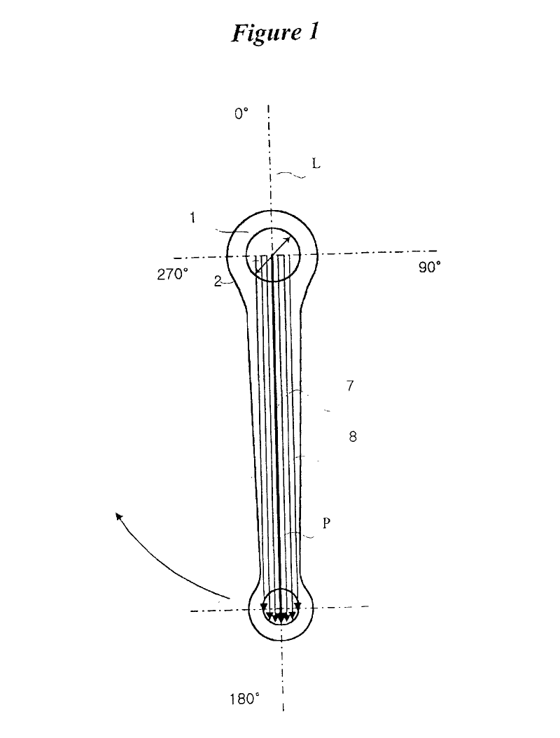

When showing a longitudinal section of a conventional crank rod into an assembly of solid lines as shown in FIG. 1, the majority of the gravity force is applied along the central line that is represented in a bold line because the line is closest to the center of the globe. Herein, the force applied along the central line is referred to as a central gravity force 7. The conventional crank rod always stops on the vertical line L due to the central gravity force 7. Only a minor gravity force is applied along other lines except for the central line. Herein, a force applied along other lines except for the central line is referred to as an eccentric gravity force. When a weight or a force more than the central gravity force 7 is exerted on a position where the eccentric gravity force 8 is applied, the position is moved to correspond to the vertical line. Thus, it is apparent that the eccentric gravity force 8 is ignorable.

Both a biased extension 3 and an intermediate transition 4 of the crank rod according to the present invention are formed to have an obtuse internal angle so that an end of the crank rod usually stops after passing over a vertical line regardless of either a weight or a force applied to the force-applying portion 6.

Hereinafter, the eccentric crank rod according to the present invention will be more specifically explained.

The biased extension and the intermediate transition of the crank rod are functioned by the eccentric gravity as if it is a seesaw. When a force is applied, an end of the main length portion and the force-applying portion are moved downward to pass over the vertical line. After passing over the vertical line, however, the weight exerted on the force-applying portion 6 eccentrically extended from the end of the main length portion is functioned as a backboard force to move the main length portion toward the vertical line L. The force-applying portion stops at a position across the vertical line so that the aforementioned two functions are proportioned with each other. At this time, the end of the main length portion stops at a more advanced position than the end of the main length portion. A distance advanced from the vertical line L varies with a length ratio and an internal angle between the biased extension and the intermediate transition, an exerted weight, a length of the main length portion, and a shape of the force-applying portion. Force conversion effect of crank rod is relied on the distance advanced from the vertical line L.

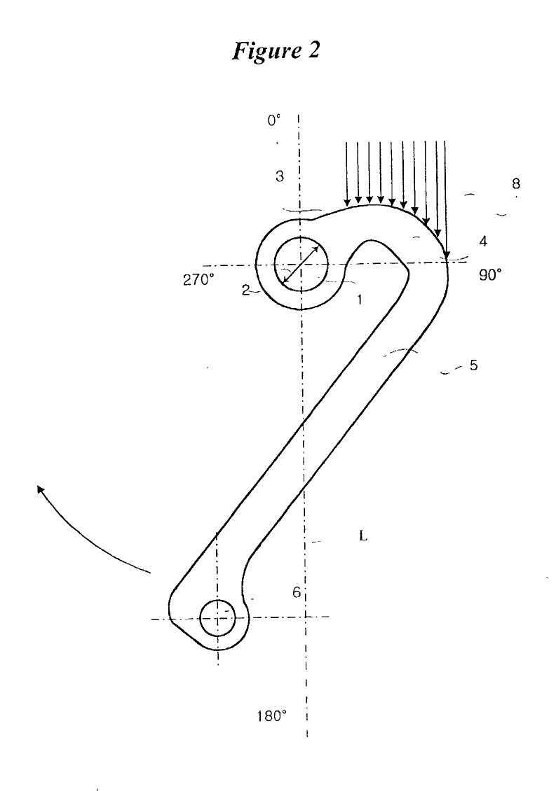

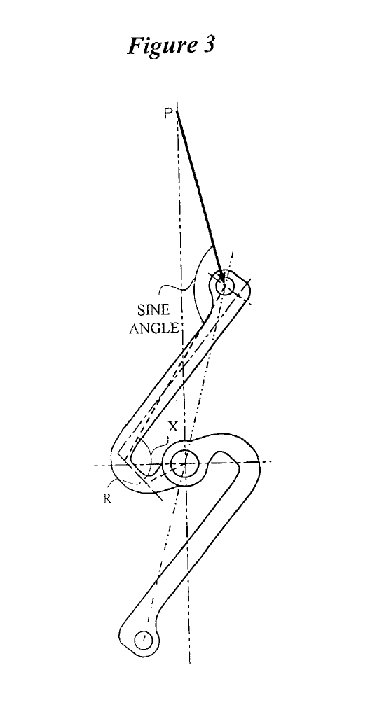

The aforementioned facts are easily understood from FIG. 2, in which both the end of the main length portion and the force-applying portion usually stop after passing over a vertical line although either a weight or a force applied to the force-applying portion 6. FIG. 3 shows a couple of crank rods used in a bicycle.

As can see from FIGS. 2 and 3, the crank rod according to a preferred embodiment of the present invention comprises the biased extension 3 extended in a direction other than the direction from the crank pin to the force-applying portion. The main length portion 5 of the crank rod extends from the force-applying portion to form the majority of the length of the crank rod. The intermediate transition 4 forms a smooth transition between the biased extension 3 and the main length portion 5 with obtuse internal angles formed at both ends.

In this embodiment, the length of the biased extension 3 to 38±15 nm and the obtuse internal angle to 115°±10° arc important factors in deciding how much the end of the main length portion and the force-applying portion pass over the vertical line. Both the length of the intermediate transition to 28±15 mm and the length of the main length portion to 178±15 mm ale important factors in deciding how much increased is a conversion effect from a linear force applied on the force-applying portion into a rotational force. As shown in FIG. 3, the biased extension extends from a crank pin insertion end of the crank rod to the intermediate transition. The intermediate transition is transited to the main length portion with an internal angle to 110°±10° formed to minimize an angle loss. Furthermore, the force-applying portion eccentrically extended from the main length portion is formed to meet the constraint of cosine 0° so that the distance, by which the end of the main length portion and the force-applying portion advance from the vertical line L, is maximized when a distance R and an angle X are set to minimize a force transmission loss. If the constraint is not met, the crank rod stops on the vertical line L when a weight is exerted on tile force-applying portion. Therefore, it is preferred that the biased extension, the intermediate transition and the main length portion have a length ratio of about 1:0.8:4.7 although the ratio can slightly vary based on a kind of crank rod.

As shown in FIG. 3, the distance, by which the end of the main length portion and the force-applying portion advance from the vertical line L, vanes relied on an amount of the weight exerted on the force-applying portion. When no weight is exerted on the force-applying portion, the distance is lengthened because of the weight of the biased extension and the intermediate transition, and the eccentric gravity. As the amount of the weight exerted on the force-applying portion is increased, the end of the main length portion and the force-applying portion stop at a more close position to the vertical line L. However, such a stop position is not closed to the vertical line in excess of threshold even though the weight exerted on the force-applying portion is increased. In other words, when a weight enough to be free from effect of the weights of the biased extension and the intermediate transition, the crank rod stops at the position at which a forwarding force by the eccentric gravity exerted on the biased extension and the intermediate transition is in proportion to a rewarding force by the central gravity and the weight exerted on the force-applying portion. FIGS. 2 and 3 show the crank rod stopped at the stop position. Therefore, even if the biased extension and the intermediate transition are excessively lengthened to increase the advanced distance, output of rotational force is not increased because the increment of the advanced distance is canceled by increments of the angle loss and the force transmission loss. From several tests, it is disclosed that output of rotational force is maximized when two constraints are met, firstly, the main length portion and the force-applying portion formed to minimize the angle loss and to increase the advanced distance, and secondly, the biased extension and the intermediate transition formed to have the minimized lengths and the obtuse internal angle to minimize the angle loss. Three times of tests are conducted by a rider on a roller having eight testing steps, whose weight is 60 Kg. The tests reveal that a conventional straight crank rod is 5.80 Kg, a crank rod according to International Application Publication WO97/02174 5.81 Kg, and a crank rod according to the invention 6.30 Kg. From the results, it is understood that a bended crank rod either not having a proper obtuse internal angle between the biased extension and the intermediate transition or not fouling the force-applying portion on a eccentric position fails in increasing the output of rotational force as if a conventional straight crank rod is.

In the crank rod according to the present invention having the biased extension, the intermediate transition, the main length portion and the eccentric force-applying portion that are specifically explained above, the end of the main length portion and the force-applying portion always stop after passing over the vertical line. Thus, it is able to quickly start, to run at a high speed, and to easily passing the highest position and the lowest position without a heavy flywheel. In a gasoline engine and a diesel engine, knocking, vibration and noise are avoided. In a geared crank rod used in a bicycle, a rider can pass over the highest position, by which he runs two times of running miles compared to a bicycle equipped with a conventional crank rod in the same energy consumption, and by which he runs two times of running speed compared to a bicycle equipped with a conventional crank rod on a hill to the elevation angle of 25° and without any change gear.

What is claimed is:

1. An eccentric crank rod having a biased extension, an intermediate transition and a force-applying portion at a main length portion, wherein said biased extension is extended from an end adapted to insert a crank pin and continued to said intermediate transition and said main length portion, and wherein said force-applying portion is provided at a position biased from the center of said crank rod adjacent to an end of said main length portion, by which said end and said force-applying portion of said main length portion usually stop after passing over a vertical line regardless of either a weight or a force applied to said force-applying portion by the gravity applied to said biased extension and said intermediate transition.

2. The eccentric crank rod according to claim 1, characterized in that said force-applying portion is formed at an off-centered position nearby an end of said main length portion, wherein said force-applying portion has a proper length and a proper angle to maximize a trigonometric sine value by an angle between a force-applying direction and said main length portion of said crank rod so that a force transmission loss is minimized.

3. The eccentric crank rod according to claim 1 or 2, characterized in that both said biased extension and said intermediate transition are directed to form an obtuse angle with adjacent portions, wherein the maximum distance between said force-applying portion and said intermediate transition equals the sum of the length of a conventional crank rod and the diameter of a crank pin with a tolerance of ±5 mm allowed.
